(19) United States
(12) Patent Application Publication
(10) Pub. No.: US 2026/0183764 A1
(43) Pub. Date: Jul. 2, 2026

(54) MICROFLUIDIC SYSTEM FOR CONTROLLING THE MOVEMENT OF CHARGED PARTICLES AND A CONTROL METHOD USING THE SAME

(71) Applicant: ZHUHAI JIEYI BIOTECHNOLOGY SCIENCE AND TECHNOLOGY CO., LTD, Zhuhai (CN)

(72) Inventors: Shaojun YANG, Zhuhai (CN); Yiyi LI, Zhuhai (CN)

(21) Appl. No.: 19/440,569

(22) Filed: Jan. 5, 2026

Related U.S. Application Data
(63) Continuation of application No. PCT/CN2023/102668, filed on Jun. 27, 2023.

(30) Foreign Application Priority Data
Jul. 7, 2022 (CN) 202210803968.2

(51) Int. Cl. B01L 3/00

(52) U.S. Cl. CPC B01L 3/502761; B01L 2200/0647; B01L 2400/0415

(57) ABSTRACT

A microfluidic system for controlling movement of charged particles, including a microfluidic channel, at least three electrodes, a plurality of conductor leads and at least two drive power supplies. Each electrode is in electrical contact with the electrolyte, and a pseudo-capacitance, a double-layer capacitance or a combination thereof is formed at an electrode-electrolyte interface. Each drive power supply periodically produces a voltage or current excitation, and is connected to one or more electrodes via the conductor leads. Each electrode continuously undergoes charging-discharging alternating cycles to form a traveling-wave electric field in the microfluidic channel. A maximum charge capacity of each electrode is greater than a total amount of charges transferred thereon during a charging or discharging process. A control method based on the microfluidic system is also provided.

### CROSS-REFERENCE TO RELATED APPLICATIONS

This application is a continuation of International Patent Application No. PCT/CN2023/102668, filed on Jun. 27, 2023, which claims the benefit of priority from Chinese Patent Application No. 202210803968.2, filed on Jul. 7, 2022. The content of the aforementioned application, including any intervening amendments made thereto, is incorporated herein by reference in its entirety.

### TECHNICAL FIELD

This application relates to operation and control of charged particles in electrolytes, and more particularly to a microfluidic system for controlling movement of charged particles and a control method using the same.

### BACKGROUND

Charged particles in a liquid or colloid sample are forced to move under the action of an electric field. Therefore, by introducing an electric current into a liquid or colloidal electrolyte to form an electric field, it is feasible to manipulate and control the fluid or charged particles therein.

Currently, the methods to introduce the electric current into the fluid mainly involves the use of a conductor electrode, such as a graphite electrode, an alloy electrode or a solid metal (e.g., gold and platinum).

During the operation of the conductor electrode, the carriers in an electrolyte solution are ions, while the carriers in the conductor electrode are electrons. Therefore, an electrochemical reaction will inevitably occur at the electrode-fluid interface due to the charge transfer of the carriers. Accompanied by the development of the electrochemical reaction, the bubbles will be generated, and cannot be eliminated during the operation of the conductor electrode. Particularly, in a typical aqueous working fluid, hydrogen ions near the cathode will accept electrons to produce hydrogen gas, and oxygen ions near the anode will lose electrons to produce oxygen gas. In a microchannel fluidic system, the bubbles will cause a dramatic change in the local fluid pressure due to the scale effect, thereby leading to obstruction or various adverse effects on the transport, monitoring and control of the microfluid. Local bubbles are a primary cause of microfluidic chip failures. In addition, the bubbles generated by the electrochemical reaction will be gathered around the electrode, causing a decline in the electrode conductivity as well as additional energy consumption. In an electrolyte system involving various particles, more complex electrochemical reactions will occur, thereby significantly affecting pH of the working environment. These uncontrollable factors will seriously restrict the use of the conductor electrode.

In the technical solutions disclosed by U.S. Pat. No. 6,890,409 B2, the electrode is separated from the microchannel to prevent the bubbles from entering the microfluid. However, this solution involves an additional channel to separate the bubbles generated by the electrode from the microchannel, and thus is not suitable for a closed fluidic channel.

International patent publication No. 2011102801 A1 discloses an electrode made from a pseudo-capacitive material based on a pi-conjugated complex, where by means of the reversible redox reaction of the conjugated complex, the electrochemical reaction at the interface between the solid electrode and the fluid electrolyte can be eliminated, thereby fundamentally solving the problem of bubble generation. However, the pseudo-capacitive material stores energy primarily through reversible redox reactions that occur at the surface of the electrode material, so that it often needs to activate the electrode in advance during use. Specifically, the pseudo-capacitive material-based electrode is oxidized or reduced while serving as cathode or anode (equivalent to charging the electrochemical capacitor), thereby making its operation more complicated. In addition, the charged electrode has a certain discharge capacity, and once the discharge capacity exceeds the electrode capacity, the electrode will undergo an electrolysis reaction. Therefore, such electrode fails to support the prolonged and continuous operation or requires a larger electric current.

Chinese patent No. 100455328 C discloses a cell wall electroporation method using a pulsed electric field offered by a waveform generator, in which the electric field generated between multiple parallel electrodes is used to achieve the cell wall electroporation. Through the excitation of reciprocating current between the electrodes, an alternating electric field is generated to minimize the electrode-electrolysis reaction. However, this method cannot avoid the carrier transfer process between the electrode and the electrolyte (i.e., the electrolysis reaction), the practical application and effect are greatly limited.

Chinese patent No. 1181337 C discloses a method and kit for controlling microparticles in the liquid by using dielectrophoresis and traveling-wave electric field, where based on migration characteristics of the particles in the presence of a traveling-wave electric field, the microparticles in the liquid are controlled by said electric field generated on a microelectrode array. The controlled particles can be cells, bacteria, viruses, biomolecules, plastic microspheres or bubbles. The dielectrophoresis is performed based on the force applied to charged particles in a non-uniform electric field to reach the control effect, such that there is no need for an external driving current, thereby eliminating the electrode-electrolysis reaction. However, since the electrolyte is electrically conductive, an extremely-high electric field gradient is needed in the fluid to effectively control the charged particles therein, which will seriously limit the practical application of this technical solution. Typically, the dielectrophoresis fails to effectively control submicron-scale particles.

In summary, the existing technologies struggle with the following drawbacks.

(1) Ordinary electrodes suffer from the electrode-electrolysis reaction and resultant adverse effects, which greatly limits the application in microfluidic channel systems. For example, the ordinary electrode driven by the high-frequency traveling-wave is a temporary solution with limited use scenarios.

(2) The pseudo-capacitive material-based electrode struggle with the capacitive charge limitation, making it difficult for the traditional electrophoresis methods to meet requirements for continuous and long-term operation.

(3) Traveling-wave dielectrophoresis requires a high electric field gradient in the conductive electrolyte, which significantly limits the application range and reduces the use efficiency. Moreover, it cannot offer effective control for the nanoparticles.

### SUMMARY

An object of the present disclosure is to provide a microfluidic system for controlling movement of charged particles and a control method using the same to address the above problems in the prior art.

In order to achieve the above object, the following technical solutions are adopted.

A microfluidic system for controlling movement of charged particles, comprising:
a microfluidic channel;
at least three electrodes;
a plurality of conductor leads; and
at least two drive power supplies;
wherein the microfluidic channel is configured to allow an electrolyte containing charged particles to flow therein;
each of the at least three electrodes is in electrical contact with the electrolyte to form a pseudo-capacitance, a double-layer capacitance or a combination thereof at an electrode-electrolyte interface;
each of the at least two drive power supplies is configured to periodically output a voltage excitation or a current excitation; the voltage excitation or the current excitation is configured to dynamically vary within a single output cycle; and each of the at least two drive power supplies is connected to at least one electrode among the at least three electrodes via the at least one conductor lead among the plurality of conductor leads; and
each of the at least three electrodes is configured to continuously undergo alternating cycles of charging and discharging to form a traveling-wave electric field with a periodically-varying amplitude in the microfluidic channel; the traveling-wave electric field is configured to move at a preset traveling-wave propagation speed; the charged particles are configured to move under an action of the traveling-wave electric field; and a maximum charge capacity of each of the at least three electrodes is greater than a total amount of charges transferred thereon during a single charging or discharging process.

In an embodiment, a moving direction of the traveling-wave electric field is the same as or opposite to a flow direction of the electrolyte; the traveling-wave electric field has a positive amplitude Ep and a negative amplitude En, wherein the positive amplitude Ep is not equal to the negative amplitude En; a time-domain span of the positive amplitude Ep is Tp; a time-domain span of the negative amplitude En is Tn; and the traveling-wave electric field satisfies the following formula (1):

$$E p \times T p = E n \times T n . \qquad ( 1 )$$

In an embodiment, the microfluidic channel has an inner diameter ranging from 100 nm to 10 mm.

In an embodiment, the charged particles each have a diameter ranging from 0.1 nm to 0.1 mm.

In an embodiment, within one or more cycles of the traveling-wave electric field, for each of the at least three electrodes, a total input current is equal to a total output current, indicating that a net input current and a net output current on each of the at least three electrodes are both zero; or
for each of the at least three electrodes, a total input charge and a total output charge are always less than a charge capacity.

In an embodiment, each of the at least two drive power supplies is configured to be adjustable in terms of cycle, frequency, output voltage waveform, output current waveform or a combination thereof; and
the traveling-wave electric field is configured to be adjustable in terms of amplitude, positive-to-negative amplitude ratio and traveling-wave propagation speed.

In an embodiment, the microfluidic channel has a first side and a second side opposite to each other; and at least one of the first side and the second side is provided with the at least three electrodes.

In an embodiment, the charged particles are selected from the group consisting of antibodies, protein-based molecules, microcapsules, vesicles, nanomedicines, cells, cellular components and a combination thereof.

In an embodiment, at positions where the at least three electrodes are respectively located, the traveling-wave electric field has the same waveform;
at the positions where the at least three electrodes are respectively located, the traveling-wave electric field maintains the same waveform shape but different amplitudes; or
at the positions where the at least three electrodes are respectively located, the traveling-wave electric field has the same or different traveling-wave propagation speed.

The present disclosure provides a charged particles control method, the method being performed based on the aforementioned microfluidic system, and the method comprising:
(a) introducing the electrolyte into the microfluidic channel;
(b) correspondingly connecting the plurality of conductor leads to the at least two drive power supplies; and
(c) controlling each of the at least two drive power supplies to periodically output the voltage excitation or the current excitation, so as to form the traveling-wave electric field in the microfluidic channel; and
controlling, under the action of the traveling-wave electric field, the charged particles to move in the microfluidic channel;
wherein the traveling-wave electric field is configured to move at the preset traveling-wave propagation speed; the charged particles in the electrolyte are configured to move under the action of the traveling-wave electric field; and the maximum charge capacity of each of the at least three electrodes is greater than the total amount of charges transferred thereon during a single charging or discharging process.

Compared to the prior art, the present disclosure at least has the following beneficial effects.

(1) Compared to traditional electrodes, the microfluidic system and the control method provided herein address problems of electrolytic reaction occurring at the electrode to fundamentally avoid the bubble generation. Moreover, the disclosure also avoids the electrode passivation after long-term operation.

(2) Compared to other novel electrodes, the disclosure overcomes the charge capacity limitation, and has advantages of excellent long-term operational stability, strong electric current drive, and sufficient miniaturization to provide enough driving force at micron and nanometer scales.

(3) The disclosure demonstrates the following advantages over the traditional electrophoresis technologies: (i) suitable for miniaturization; (ii) precise control of the forward/backward movement of the charged particles in the electrolyte; and (iii) accurate control of charged particles at micron and nanometer scales.

(4) Compared to dielectrophoresis, the disclosure exhibits higher efficiency, and a lower driving voltage to manipulate high-velocity charged particles. Moreover, the disclosure enables the drive of charged particles with micron and nanometer scales, and precise control of the movement of the charged particles (the distortion of the local electric field gradient in dielectrophoresis will greatly affect the control accuracy).

### BRIEF DESCRIPTION OF THE DRAWINGS

In order to illustrate the technical solutions in the embodiments of the present disclosure or in the prior art more clearly, the accompanying figures needed in the description of the embodiments of the present disclosure or in the prior art will be briefly described below. Obviously, presented in the accompanying figures are merely some embodiments of the present disclosure. Other accompanying figures can also be obtained by those skilled in the art based on the figures provided herein without paying creative effort.

FIG. 1a schematically shows a device for controlling charged particles in an electrolyte according to an embodiment of the present disclosure;

FIG. 1b schematically shows a device for controlling charged particles in an electrolyte according to another embodiment of the present disclosure;

FIG. 2 schematically shows an output voltage of a drive power supply according to an embodiment of the present disclosure;

FIG. 3 schematically shows an output current of an electrode according to an embodiment of the present disclosure; and

FIG. 4 schematically shows a traveling-wave electric field according to an embodiment of the present disclosure.

In the figures: 1—microfluidic channel; 11—charged particle; 2—electrode; 3—drive power supply; 4—conductor lead; and 5—traveling-wave electric field.

### DETAILED DESCRIPTION OF EMBODIMENTS

The present disclosure will be clearly and completely described below with reference to the accompanying figures in the embodiments. Obviously, described below are merely some embodiments of the present disclosure, not all embodiments. Based on the embodiments in the present disclosure, all other embodiments obtained by those of ordinary skill in the art without paying creative labor shall fall within the scope of the present disclosure.

In the technical solutions of the present disclosure, a microfluidic channel is configured to allow an electrolyte containing charged particles to flow therein. An electrode is connected to a drive power supply. An output voltage or an output current of the drive power supply is controlled to form a traveling-wave electric field. The traveling-wave electric field is configured for controlling the charged particles to move in the microfluidic channel.

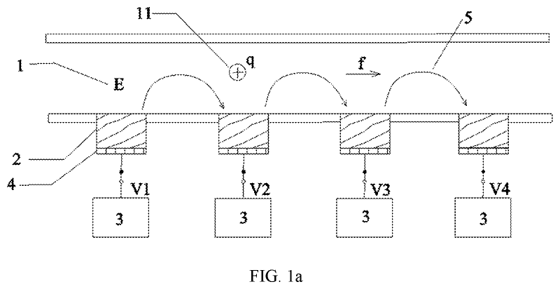

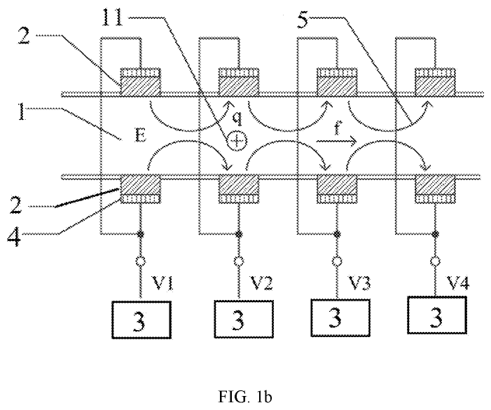

A device for controlling charged particles 11 in an electrolyte according to an embodiment of the present disclosure is schematically shown in FIG. 1a. A device for controlling charged particles 11 in an electrolyte according to another embodiment of the present disclosure is schematically shown in FIG. 1b.

Referring to FIGS. 1a-1b, the present disclosure provides a microfluidic system for controlling movement of charged particles 11, including a microfluidic channel 1, at least three electrodes 2, a plurality of conductor leads 4 and at least two drive power supplies 3.

In some embodiments, the microfluidic channel 1 is configured to allow an electrolyte containing charged particles 11 to flow therein.

In some embodiments, the electrolyte is colloid or fluid. The charged particles 11 are solid, gas or liquid. The charged particles 11 are configured to flow along with the electrolyte within the microfluidic channel 1.

In some embodiments, the charged particles 11 each have a characteristic length ranging from 0.1 nm-0.1 mm, where the characteristic length is defined by a diameter of a charged particle 11.

In some embodiments, the microfluidic channel 1 has a characteristic length ranging from 100 nm to 10 mm, where the characteristic length is defined by an inner diameter of the microfluidic channel 1.

In some embodiments, the charged particles 11 are selected from the group consisting of antibodies, protein-based molecules, microcapsules, vesicles, nanomedicines, cells, cellular components, bacteria, viruses, biomolecules, plastic microspheres, bubbles and a combination thereof.

In some embodiments, each of the at least three electrodes 2 is in electrical contact with the electrolyte to form a pseudo-capacitance, a double-layer capacitance or a combination thereof at an electrode-electrolyte interface. The microfluidic channel 1 has a first side and a second side opposite to each other. The electrodes 2 are arranged on the first side and/or the second side. In other words, the electrodes 2 are arranged on at least one side of the microfluidic channel 1, and for each side, the number of the electrodes 2 is 0 or ≥3. When one side of the microfluidic channel 1 is provided with the electrodes 2, the number of the electrodes 2 is not less than three, which is necessary for forming the traveling-wave electric field 5. If the number of the at least three electrodes 2 is less than three, it will fail to form the traveling-wave electric field 5. Referring to FIG. 1a, four electrodes 2 are merely arranged on the second side. Referring to FIG. 1b, each of the first side and the second side is provided with four electrodes 2.

It should be noted that in FIGS. 1a-1b, the number of the at least three electrodes 2 is merely exemplary, and is not intended to limit the present disclosure.

In some embodiments, the number of the at least three electrodes 2 can be adjusted according to actual requirements as long as the above arrangement requirements are satisfied.

In some embodiments, each of the at least two drive power supplies 3 is configured to periodically output a voltage excitation or a current excitation. The voltage excitation or the current excitation is configured to dynamically vary within a single output cycle. Specifically, within at least some time of the single output cycle, for each of the at least two drive power supplies 3, a voltage amplitude or a current amplitude is configured to dynamically vary, while remaining constant within the rest time of the single output cycle.

In some embodiments, each of the at least two drive power supplies 3 is connected to at least one electrode 2 among the at least three electrodes 2 via at least one conductor lead 4 among the plurality of conductor leads 4. Each of the plurality of conductor leads 4 is configured to transport the current excitation or the voltage excitation to each of the at least three electrodes 2, so as to drive the charged particles 11 in the electrolyte to generate a current and enable a complete conductive path.

In some embodiments, each of the at least three electrodes 2 is configured to continuously undergo alternating cycles of charging and discharging to form a traveling-wave electric field 5 in the microfluidic channel 1. The traveling-wave electric field 5 is configured to move at a preset traveling-wave propagation speed. The charged particles 11 are configured to move under an action of the traveling-wave electric field 5. A maximum charge capacity of each of the at least three electrodes 2 is greater than a total amount of charges transferred thereon during a single charging or discharging process.

In some embodiments, a moving direction of the traveling-wave electric field 5 is the same as or opposite to a flow direction of the electrolyte. Referring to FIGS. 1a-1b, the moving direction of the traveling-wave electric field 5 is the same as the flow direction of the electrolyte.

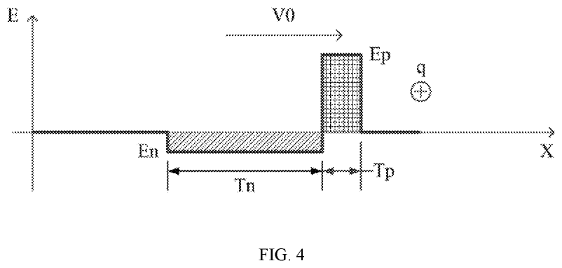

A traveling-wave electric field 5 is schematically shown in FIG. 4. The traveling-wave electric field 5 has a positive amplitude Ep and a negative amplitude En, where the positive amplitude Ep is not equal to the negative amplitude En. A time-domain span of the positive amplitude Ep is Tp. A time-domain span of the negative amplitude En is Tn. The traveling-wave electric field 5 satisfies the following formula (1):

$$E p \times T p = E n \times T n . \qquad ( 1 )$$

The traveling-wave electric field 5 provided herein satisfies the following features.

(1) Within one or more cycles of the traveling-wave electric field 5, for each of the at least three electrodes 2, a total input current is equal to a total output current, which indicates that a net input current and a net output current on each of the at least three electrodes are both zero. Or for each of the at least three electrodes 2, a total input charge and a total output charge are always less than a charge capacity.

In the practical design, for each of the at least three electrodes 2, a minor and negligible difference between the net input current and the net output current is permissible. Nevertheless, even if the net input current is different from the net output current, charges supplied by each of the at least three electrodes 2 cannot exceed its charge capacity at any moment.

(2) The traveling-wave electric field 5 is configured to be adjustable in terms of amplitude, positive-to-negative amplitude ratio and traveling-wave propagation speed.

In some embodiments, each of the at least two drive power supplies 3 is configured to be adjustable in terms of cycle, frequency, output voltage waveform, output current waveform or a combination thereof.

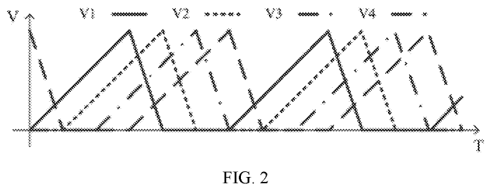

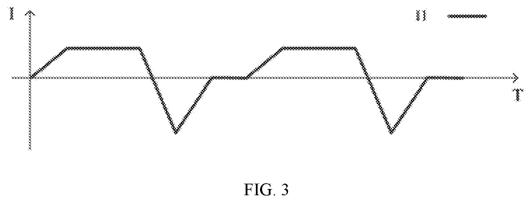

Referring to FIG. 2, the output voltage waveform includes a first phase, a second phase and a third phase within the single output cycle. The output voltage is configured to increase at a first slope to a maximum value within the first phase. The output voltage is configured to decrease at a second slope to zero within the second phase. The output voltage is configured to remain zero within the third phase. In actual implementation, each of the at least two drive power supplies 3 is configured to be adjustable in terms of single output cycle, output voltage waveform and output current waveform. Moreover, the output voltage waveform or the output current waveform is not limited to it as shown in FIGS. 2-3. The output voltage waveform or the output current waveform can be adjusted to a desired waveform as needed. When adjusting the at least two drive power supplies 3, it is not limited to whether the at least three electrodes 2 are working or not. In other words, during operation, the single output cycle, the output voltage waveform and the output current waveform of each of the plurality of drive power supplies 3 can be adjusted with time to generate corresponding changes of the traveling-wave electric field 5. This reflects the control of the at least three electrodes 2 and the traveling-wave electric field 5 from a temporal dimension.

In some embodiments, the traveling-wave electric field 5 is configured to be adjustable in terms of amplitude, positive-to-negative amplitude ratio and traveling-wave propagation speed. The adjustment of the traveling-wave electric field 5 is mainly based on the adjustment of the at least two driving power supplies 3. According to specific values of the above to-be-adjusted parameters, output parameters of the at least two driving power supplies 3 are respectively calculated, thereby making corresponding adjustments.

In some embodiments, the output voltage waveform of each of the at least two driver power supplies 3 is the same. A voltage phase of each of the at least two drive power supplies 3 is configured to increase or decrease uniformly along an axial direction of the microfluidic channel 1 in sequence. The purpose of such a configuration is to output a voltage from the same source to the at least two driver power supplies 3 by means of phase delay, so as to facilitate practical operation and save implementation costs.

In some embodiments, the output voltage of each of the at least two driving power supplies 3 is configured as other waveforms, as long as the traveling-wave electric field 5 with the preset traveling-wave propagation speed is formed in the microfluidic channel 1. The above embodiments are not intended to limit this disclosure.

An output voltage of a drive power supply 3 according to an embodiment of the present disclosure is schematically shown in FIG. 2. Referring to FIGS. 1a-1b and FIG. 2, the output voltages of four drive power supplies 3 from left to right are represented by V1 to V4, respectively, and output voltage waveforms thereof are shown in FIG. 2. The output voltage waveforms of V1 to V4 are the same. If V1 is set as a reference, the output voltage waveforms of V2 to V4 are obtained by means of phase delay based on V1. Moreover, a phase is configured to decrease uniformly, indicating that each output voltage waveform is configured to decrease by the same phase compared to a previous output voltage waveform.

Referring to an embodiment of FIG. 2, at the positions where the at least three electrodes 2 are respectively located, the traveling-wave electric field 5 has the same waveform. Or at the positions where the at least three electrodes 2 are respectively located, the traveling-wave electric field 5 maintains the same waveform shape but different amplitudes.

In some embodiments, at the positions where the at least three electrodes 2 are respectively located, the traveling-wave electric field 5 has the same or different traveling-wave propagation speed. If there is a need to adjust the traveling-wave propagation speed of the traveling-wave electric field 5 at different positions in the space, it can be satisfied by regulating an alternating speed of an output voltage of a corresponding electrode 2 at that position. The alternating speed of the output voltage is configured to correspond to the single output cycle of each of the at least two driving power supplies 3. In other words, by controlling a single output cycle of a drive power supply 3 connected to the corresponding electrode 2 at that position, the traveling-wave electric field 5 can be controlled to have a different traveling-wave propagation speed at different positions along the moving direction thereof. Generally, the faster the alternating speed of the output voltage (corresponding to the shorter the single output cycle of the drive power supply 3), the faster the traveling-wave propagation speed. The slower the alternating speed of the output voltage (corresponding to the longer the single output cycle of the driving power supply 3), the slower the traveling-wave propagation speed. It serves as the basis for controlling the traveling-wave propagation speed, and reflects the control of the at least three electrodes 2 and the traveling-wave electric field 5 from the temporal dimension.

Referring to FIG. 2, based on the above output voltage waveforms of each of the at least two drive power supplies 3, a voltage difference is generated between the at least three electrodes 2. The voltage difference causes the charged particles 11 in the electrolyte to flow, thereby generating a current. The current is configured to flow from an electrode 2 with a higher voltage to an electrode 2 with a lower voltage. The high voltage and the low voltage are relative to each other.

An output current of each of a plurality of electrodes 2 according to an embodiment of the present disclosure is schematically shown in FIG. 3. The output current is a current of an electrode 2 connected to VL. When a voltage of the electrode 2 connected to V1 (the voltage is a relative voltage between the at least three electrodes 2, the same below) is positive, the electrode 2 operates in an anode mode, where the current of the electrode 2 is positive (as shown in FIG. 3), indicating that the current flows out of the electrode 2 and towards an adjacent electrode 2 with a relatively lower voltage. When a voltage of the electrode 2 connected to V1 is 0, the current of the electrode 2 is also 0. There is neither current flowing into nor out of the electrode 2. When a voltage of the electrode 2 connected to V1 is negative, the electrode 2 operates in a cathode mode, where the current of the electrode 2 is negative, indicating that the current flows into the electrode 2. Consequently, for each of the at least three electrodes 2, the voltage varying with time causes it to undergo charging-discharging alternating cycles. The charging-discharging alternating cycles are configured to alternate back and forth to form a reciprocating current. The traveling-wave electric field 5 is configured to drive the charged particles 11 to move, so as to generate the current on each of the at least three electrodes 2. An average current on each of the at least three electrodes 2 is 0.

Referring to FIG. 3, the reciprocating current does not exist all the time. During a single cycle when the voltage difference between the electrode 2 and the adjacent electrode 2 is 0, the current of the electrode 2 is 0. At other moments, magnitude and direction of the current are related to the voltage difference. The present disclosure controls the fluid or the charged particles 11 in the fluid by alternately charging and discharging the at least three electrodes 2 in time or space to form a periodically-varying electric field or current in the microfluidic channel 1. At the same time, since the carrier transformation is completed within the at least three electrodes 2, no electrolytic reactions will occur, fundamentally avoiding the bubble generation in the fluid.

The at least three electrodes 2 are each a double-layer capacitive electrode, a pseudo-capacitive electrode or a combination thereof. The maximum charge capacity of each of the at least three electrodes 2 is greater than the total amount of charges transferred thereon during a charging or discharging process. The at least three electrodes 2 are configured to operate alternately at different times. The double-layer capacitive electrodes include electrodes of double-layer capacitors. The pseudo-capacitive electrodes include electrodes of pseudo-capacitors. The double-layer capacitive electrodes achieve charge storage based on a net charge adsorption of charged particles 11 in the electrolyte on a surface of each of the at least three electrodes 2 to form a double electric layer. There is no redox reaction involved, fundamentally avoiding the bubble generation.

The pseudo-capacitive electrodes store and release electrical energy through continuous, reversible and phase change-free Faradaic reactions that occur in an electrode material at a specific potential. No bubbles are generated at an electrode interface. The pseudo-capacitive electrodes have a superior charge capacity. Each of the at least three electrodes 2 has characteristics of double-layer capacitance or pseudo-capacitance, or simultaneously has characteristics of double-layer capacitance and pseudo-capacitance as a composite form. For instance, electrodes composed of materials mixed with graphene and metal oxides in a certain proportion will simultaneously have characteristics of pseudo-capacitance and double-layer capacitance.

Due to different effects of the traveling-wave electric field 5 on charged particles 11 with different charge-to-mass ratios, by precisely controlling the amplitude and the traveling-wave propagation speed of the traveling-wave electric field 5, the charged particles 11 can be precisely controlled. The detailed description is illustrated as follows.

FIG. 4 is a schematic diagram of a traveling-wave electric field 5 according to an embodiment of the present disclosure, presenting a waveform of the traveling-wave electric field 5 at a specific moment. Since the traveling-wave electric field 5 moves at a traveling-wave propagation speed V0, the waveform of the traveling-wave electric field 5 needs to be determined according to a specific moment t and a value of V0 at other moments. A horizontal axis in FIG. 4 represents an axis from left to right along the microfluidic channel 1, and a vertical axis represents the amplitude of the traveling-wave electric field 5.

The traveling-wave electric field 5 shown in FIG. 4 is configured to move at the traveling-wave propagation speed V0 in the microfluidic channel 1. Since the traveling-wave electric field 5 exhibits equal magnitude but opposite direction in a product of time and amplitude for an interval where an electric field Ep is positive and an interval where an electric field En is negative, i.e., Ep×Tp=En×Tn as shown in FIG. 4, an average charge output by each of the at least three electrodes 2 within the single output cycle is zero, which indicates that a total amount of charges input into each of the at least three electrodes 2 is equal to a total amount of charged output by each of the at least three electrodes 2. Given that a strength of Ep is n times that of En, i.e., En=E0, Ep=n×E0, then Tp is 1/n of Tn, so that Tp=T0, and Tn=n×T0.

When a front edge of the traveling-wave electric field 5 initially acts on a charged particle 11 with a charge q, given that the charged particle 11 is subjected to a force of the electric field n×E0×q, a migration velocity proportional to the force of the electric field is generated under the combined action of the force of the electric field, viscous force of liquid, frictional resistance. Consequently, the migration velocity of the charged particle q in the electric field Ep is represented by Vqp, and Vqp=k×Ep=k×n×E0. The migration velocity of the charged particle q in the electric field En is represented by Vqn, and Vqn=k×E0. Since Tp=T0 and Tn=n×T0, Vqp×Tp=Vqn×Tn=k×n×E0×T0.

Since the traveling-wave electric field 5 moves forward in time, when the migration velocity Vq of the charged particle 11 with the charge q is greater than V0, During the rising edge of an electric field Ep, the electric field Ep pulse acting on the charged particle 11 under continuous action of the Ep pulse, the charged particle 11 is configured to move forward along with the movement of the electric field Ep.

When the migration velocity Vq of the charged particle 11 with the charge q is slightly smaller than V0, the charged particle 11 is configured to move forward along with the traveling-wave electric field 5 for a period of time, such that the time for the electric field Ep acting on the charged particle 11 with the charge q is greater than the time-domain span Tp. However, since the electric field En has an opposite direction, the charged particle 11 with the charge q moves backward under the action of the electric field En, such that the time for the electric field En acting on the charged particle 11 with the charge q is less than the time-domain span Tn. Due to the above two factors, the charged particle 11 with the charge q is configured to move forward for a certain distance after the single output cycle of the electric field.

If the migration velocity Vq of the charged particle 11 with the charge q is much less than V0, the influence of V0 on an action time of the traveling-wave electric field 5 can be ignored. In this case, since a product of the action time of the electric field Eq on the charged particle 11 with the charge q is almost equal to a product of the action time of the electric field En on the charged particle 11 with the charge q, the displacements that the charged particle 11 moves forward and backward are also almost equal. Therefore, after the single cycle of the traveling-wave electric field 5, the displacement of the charged particle 11 is almost zero.

In some embodiments, when the migration velocity of the charged particle 11 with the charge q is less than V0, the charged particle 11 with the charge q is initially acted by the Ep pulse to move forward for a displacement expressed as V0×Vqp×Tp/(V0−Vqp) approximately. Then, it is acted by the En pulse to move backward for a displacement expressed as V0×Vqn×Tn/(V0+Vqn) approximately. Since a direction of the migration velocity Vp of the charged particle 11 with the charge q is the same as a direction of V0, the time for the electric field Ep acting on the charged particle 11 with the charge q is greater than the time-domain span Tp, while the time for the electric field En acting on the charged particle 11 with charge q is less than the time-domain span Tn. After the single output cycle of the traveling-wave electric field 5, the displacement that the charged particle 11 with the charge q moves forward is determined by a ratio of V0 to Vq, the time-domain span Tn, and the time-domain span Tp, etc.

In summary, the present disclosure can precisely control the charged particles 11 with different charge-mass ratios in the electrolyte by adjusting the value of Vq and the specific waveform of the electric field. Moreover, various operations such as sorting, enrichment, or separation of the charged particles 11 can be performed by adjusting the traveling-wave propagation speed and amplitude of the traveling-wave electric field 5 at different times and/or positions.

The present disclosure adopts each of the at least three electrodes 2 with larger charge capacity, so as to provide charge buffering for the overall system, thereby reducing charge consumption during operation and maintaining stability of long-term charging-discharging cycles for the overall system.

The present disclosure provides a charged particles control method based on the aforementioned microfluidic system. The method is performed through the following steps.
(a) The electrolyte is introduced into the microfluidic channel 1.
(b) The plurality of conductor leads 4 are correspondingly connected to the at least two drive power supplies 3.
(c) Each of the at least two drive power supplies 3 is controlled to periodically output the voltage excitation or the current excitation, so as to form the traveling-wave electric field 5 in the microfluidic channel 1.

Under the action of the traveling-wave electric field 5, the charged particles 11 are controlled to move in the microfluidic channel 1.

The traveling-wave electric field 5 is configured to move at the preset traveling-wave propagation speed. The charged particles 11 in the electrolyte are configured to move under the action of the traveling-wave electric field 5. The maximum charge capacity of each of the at least three electrodes 2 is greater than the total amount of charges transferred thereon during a single charging or discharging process.

Compared to the prior art, the present disclosure at least has the following beneficial effects.

(1) Compared to traditional electrodes, the microfluidic system and the control method provided herein addresses problems of electrolytic reaction occurring at the electrode to fundamentally avoid the bubble generation. Moreover, the disclosure also avoids the electrode passivation after long-term operation.

(2) Compared to other novel electrodes, the disclosure overcomes the charge capacity limitation, and has advantages of excellent long-term operational stability, strong electric current drive, and sufficient miniaturization to provide enough driving force at micron and nanometer scales.

(3) The disclosure demonstrates the following advantages over the traditional electrophoresis technologies: (i) suitable for miniaturization; (ii) precise control of forward/backward movements of the charged particles 11 in the electrolyte; and (iii) accurate control of charged particles with micron and nanometer scales.

(4) Compared to dielectrophoresis, the disclosure exhibits higher efficiency, and a lower driving voltage to manipulate high-velocity charged particles. Moreover, the disclosure enables the drive of charged particles with micron and nanometer scales, and precise control of the movement of the charged particles (the distortion of the local electric field gradient in dielectrophoresis will greatly affect the control accuracy).

During operation, the at least three electrodes 2 are configured to continuously undergo alternating cycles of charging and discharging in time or space, thereby forming a periodically-varying electric field or electric current in the microfluidic channel 1. This enables the control of the fluid or the charged particles 11 within the fluid. Additionally, since carrier electrons are transformed within the at least three electrodes 2, no electrolysis reactions will occur on the surface of each of the at least three electrodes 2, thereby avoiding the bubble generation in the fluid. The traveling-wave electric field 5 has asymmetric positive and negative amplitudes, so that the input current and output current of the same electrode 2 are asymmetric within different phases of the single output cycle of the traveling-wave electric field 5, but the input current and output current of each of the at least three electrodes 2 are equal within the single output cycle of the traveling-wave electric field 5. At the same time, each of the at least three electrodes 2 with larger charge capacity provides the charge buffering for the overall microfluidic system, reducing charge consumption during operation and maintaining the stability of the long-term charging-discharging cycles. The charging-discharging alternating cycles are performed on each of the at least three electrodes 2 in time to supply current drive, thereby achieving the control of the fluid or the charged particles 11 in the fluid, and realizing the combined regulation of charging-discharging alternating cycles and electric drive phenomena. The at least three electrodes 2 are configured to operate alternately at different times, significantly reducing the requirement for the charge capacity of each of the at least three electrodes 2. By means of this, a size of each of the at least three electrodes 2 is easy to control, and suitable for microsystems at the micron and nanometer scales. Since the at least three electrodes 2 fundamentally eliminate redox reactions at an electrode interface, and have an alternating operation mode at different times, there is a very strong self-cleaning function of the at least three electrodes 2. It minimizes electrode passivation and various failures caused by phenomena such as electrodeposition and redox of the at least three electrodes 2 to the greatest extent, and greatly extends the service life of the at least three electrodes 2.

It should be understood that for those skilled in the art, each of the accompanying figures is a schematic diagram of an embodiment, and modules or processes in the accompanying figures are not necessarily required for the implementation of the embodiments of the present disclosure.

It should be understood that for those skilled in the art, the modules of the device presented in the embodiments can be arranged in the device according to the description of the embodiments, and can also be arranged in at least one device according to other ways different from those described herein. The modules can be combined with each other to form an integrated module, or be further divided into a plurality of sub-modules.

It should be noted that the embodiments described above are merely illustrative, and are not intended to limit the present disclosure. Although the disclosure has been described in detail above with reference to the embodiments, for those skilled in the art, various modifications and equivalent replacements can still be made to the technical solutions of the embodiments. It should be understood that those replacements and modifications made without departing from the scope and spirit of the present disclosure shall fall within the scope of the disclosure defined by the appended claims.

What is claimed is:

1. A microfluidic system for controlling movement of charged particles, comprising:
a microfluidic channel;
at least three electrodes;
a plurality of conductor leads; and
at least two drive power supplies;
wherein the microfluidic channel is configured to allow an electrolyte containing charged particles to flow therein;
each of the at least three electrodes is in electrical contact with the electrolyte to form a pseudo-capacitance, a double-layer capacitance or a combination thereof at an electrode-electrolyte interface;
each of the at least two drive power supplies is configured to periodically output a voltage excitation or a current excitation; the voltage excitation or the current excitation is configured to dynamically vary within a single output cycle; and each of the at least two drive power supplies is connected to at least one electrode among the at least three electrodes via the at least one conductor lead among the plurality of conductor leads; and
each of the at least three electrodes is configured to continuously undergo alternating cycles of charging and discharging to form a traveling-wave electric field with a periodically-varying amplitude in the microfluidic channel; the traveling-wave electric field is configured to move at a preset traveling-wave propagation speed; the charged particles in the electrolyte are configured to move under an action of the traveling-wave electric field; and a maximum charge capacity of each of the at least three electrodes is greater than a total amount of charges transferred thereon during a single charging or discharging process.

2. The microfluidic system of claim 1, wherein a moving direction of the traveling-wave electric field is the same as or opposite to a flow direction of the electrolyte; the traveling-wave electric field has a positive amplitude Ep and a negative amplitude En, wherein the positive amplitude Ep is not equal to the negative amplitude En; a time-domain span of the positive amplitude Ep is Tp; a time-domain span of the negative amplitude En is Tn; and the traveling-wave electric field satisfies the following formula (1):
$$E p \times T p = E n \times T n . \qquad ( 1 )$$

3. The microfluidic system of claim 1, wherein the microfluidic channel has an inner diameter ranging from 100 nm to 10 mm.

4. The microfluidic system of claim 1, wherein the charged particles each have a diameter ranging from 0.1 nm to 0.1 mm.

5. The microfluidic system of claim 1, wherein within one or more cycles of the traveling-wave electric field, for each of the at least three electrodes, a total input current is equal to a total output current, indicating that a net input current and a net output current on each of the at least three electrodes are both zero; or
for each of the at least three electrodes, a total input charge and a total output charge are always less than a charge capacity.

6. The microfluidic system of claim 1, wherein each of the at least two drive power supplies is configured to be adjustable in terms of cycle, frequency, output voltage waveform, output current waveform or a combination thereof, and
the traveling-wave electric field is configured to be adjustable in terms of amplitude, positive-to-negative amplitude ratio and traveling-wave propagation speed.

7. The microfluidic system of claim 1, wherein the microfluidic channel has a first side and a second side opposite to each other; and at least one of the first side and the second side is provided with the at least three electrodes.

8. The microfluidic system of claim 1, wherein the charged particles are selected from the group consisting of antibodies, protein-based molecules, microcapsules, vesicles, nanomedicines, cells, cellular components and a combination thereof.

9. The microfluidic system of claim 1, wherein at positions where the at least three electrodes are respectively located, the traveling-wave electric field has the same waveform;
at the positions where the at least three electrodes are respectively located, the traveling-wave electric field maintains the same waveform shape but different amplitudes; or
at the positions where the at least three electrodes are respectively located, the traveling-wave electric field has the same or different traveling-wave propagation speed.

10. A charged particles control method, the method being performed based on the microfluidic system of claim 1, and the method comprising:
(a) introducing the electrolyte into the microfluidic channel;
(b) correspondingly connecting the plurality of conductor leads to the at least two drive power supplies; and
(c) controlling each of the at least two drive power supplies to periodically output the voltage excitation or the current excitation, so as to form the traveling-wave electric field in the microfluidic channel; and
controlling, under the action of the traveling-wave electric field, the charged particles to move in the microfluidic channel;
wherein the traveling-wave electric field is configured to move at the preset traveling-wave propagation speed; the charged particles in the electrolyte are configured to move under the action of the traveling-wave electric field; and the maximum charge capacity of each of the at least three electrodes is greater than the total amount of charges transferred thereon during a single charging or discharging process.
